(19) United States
(12) Patent Application Publication
(10) Pub. No.: US 2014/0211977 A1
(43) Pub. Date: Jul. 31, 2014

(54) OVER/UNDER DUAL-FIT WEARING OPTION EARPHONES

(71) Applicant: Judd Armstrong, Salt Lake City, UT (US)

(72) Inventor: Judd Armstrong, Salt Lake City, UT (US)

(21) Appl. No.: 14/082,033

(22) Filed: Jan. 29, 2014

Related U.S. Application Data
(60) Provisional application No. 61/727,638, filed on Nov. 16, 2012.

(51) Int. Cl. H04R 1/10

(52) U.S. Cl. CPC H04R 1/105
USPC 381/380

(57) ABSTRACT

The invention relates to an earphone that can be worn so that the cord attached to the earphone can be worn either over the wearer's ear or under the wearer's ear because of an angled earphone tip and angled strain relief. The angled earphone tip and angled strain relief serve to provide a customizable secure fit that maximizes the sound coming through the earphones and minimizes discomfort from wearing the earphone.

### CROSS REFERENCE TO RELATED APPLICATION

This application claims the benefit of U.S. Provisional Application Ser. No. 61/727,638 filed Nov. 16, 2012 by Judd Armstrong.

### FIELD OF THE INVENTION

The present invention relates generally to the field of customizable fit earphones, and more particularly to customizable fit earphones that use multiple means for ensuring a proper and secure fit that can be worn in an over ear or under ear option.

### BACKGROUND OF THE INVENTION

With the proliferation of bluetooth devices, more and more people are using earphones as part of their daily activities, including cleaning, exercising, commuting and various other activities. Because each person's ear is as unique as their fingerprints, earphones that are mass produced do not always, or even usually, fit each unique user's individual ear. Others have attempted to fix this problem by changing the earphone's ear tips or by modifying the placement of the wire. Some have even attempted to provide a device that wraps around the outside of the wearer's ear. None of these approaches permits a user to customize the fit of the earphone to their unique ear shape in an over ear or under ear option.

Moreover, the user may want to wear the earphones a certain way one time and a different way another time. If a person is engaged in work around their home or office, the may prefer the under ear fit, which also allows for a user to take advantage of a telephone option in an earphone. If a person is running mountain trails, they are more likely to choose the over ear fit, which permits the cord connecting the phones to become almost invisible.

The ear canal travels up and forward. This makes it challenging to design earphones with the flexibility to be worn in two different ways. The device of the present invention angles the earphone tip to align in the same direction the ear canal points, therefore the earphone tip runs both up and forward relative to the earphone base. This helps maintain optimum sound isolation and comfort, while also pointing the strain relief from the wearing of the earphone over the correct location on the ear for over-ear wearing. The additional inwards angle of the strain relief assists further and balances the responsibility in achieving the required angle. The angles are designed to work well in under-ear mode as well and keep the earphones snug and close to the head. It is important to note a great over-ear fit is achieved by the present invention without needing any earhooks. The over-ear fit option lifts the cord off the user's neck, liberating their wireless music experience, especially for sports and fitness.

Considerable effort has gone into the subtle angles of the strain relief and tips of the earphones in order to hold the earphones comfortably and compactly against the head in either the over ear or under ear wearing style. The ear canal runs forward and up. If the earphone tips were straight like most earphones are, the tail end of the earphone, or the strain relief, would not point in the right direction for over-ear wearing style. By angling the earphone tip forward and up, and the strain relief inwards, these earphones are highly effective at providing a snug, comfortable, secure and acoustically sound fit for either the under or over-ear wearing options without the use of cumbersome and uncomfortable earhooks.

There is a need for earphones that permit the wearer to create a customizable, snug fit and a variety of wearing options.

### SUMMARY OF THE INVENTION

This invention provides a customizable earphone fit that permits the user to wear the earphones (wired or wireless) in either an over ear or under ear manner without the use of earhooks by using precise angles and configuration options.

In one aspect of the invention, it provides improved earphones that can be easily customized to fit each individual's unique ear shape.

In another aspect of the invention, it provides earphones that will stay securely fit on the wearer's head even during strenuous activity.

In another aspect of the invention, it provides earphones that permit the wearer to adjust to their particular comfort levels, permitting the earphone to be worn for long periods of time with the earphone wires being worn either over the ear or under the ear.

To the accomplishment of the above and related aspects, the invention may be embodied in the form illustrated in the accompanying drawings. The drawings, however, are illustrative only. Variations are contemplated as being part of the invention, limited only by the scope of the claims.

### BRIEF DESCRIPTION OF THE DRAWINGS

FIG. 1 offers a perspective view of the earphones of the present invention.

FIG. 2 is a perspective view of the present invention being worn in an over ear configuration.

FIG. 3 is a perspective view of the present invention being worn in an under ear configuration.

FIG. 4 is a perspective view of the present invention.

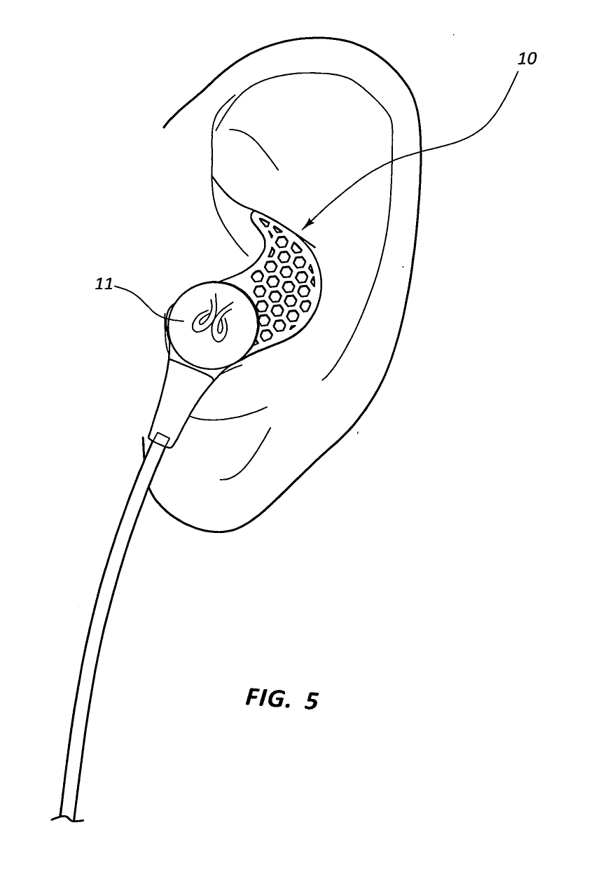

### DETAILED DESCRIPTION OF THE INVENTION

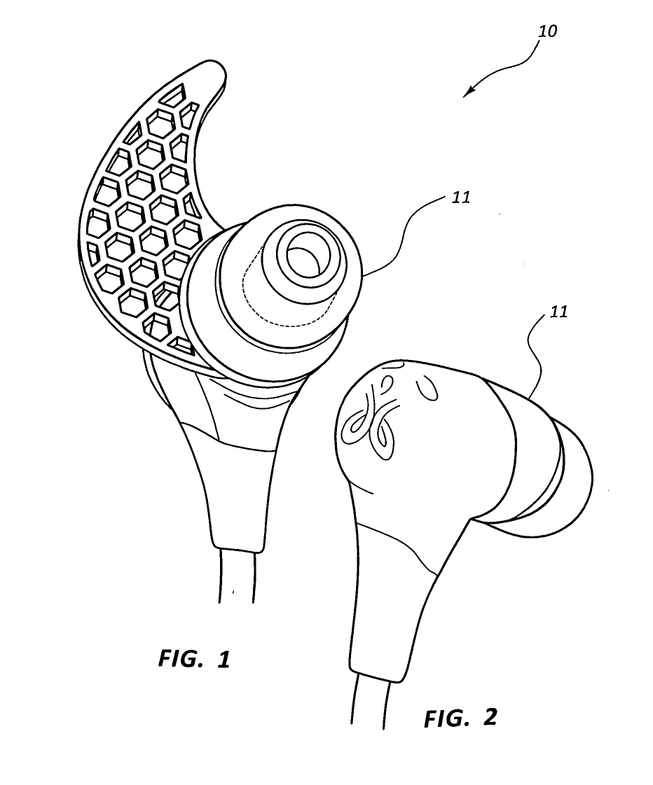

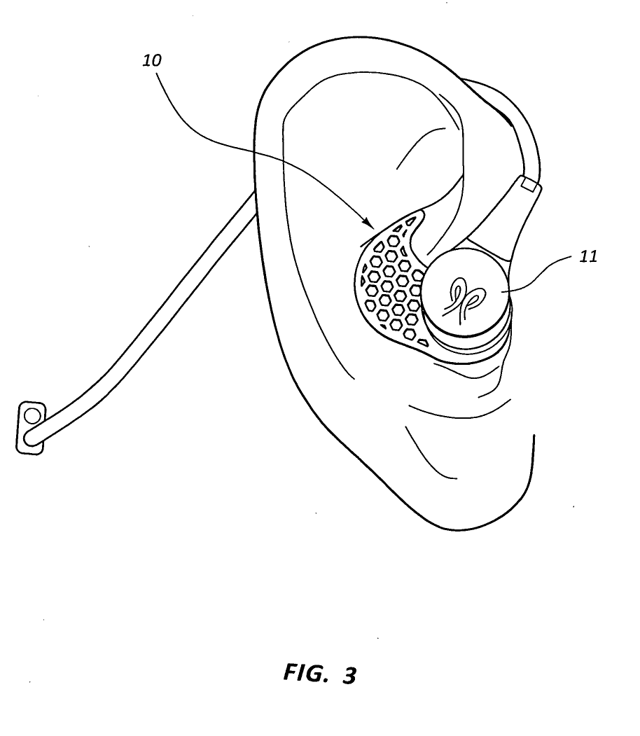

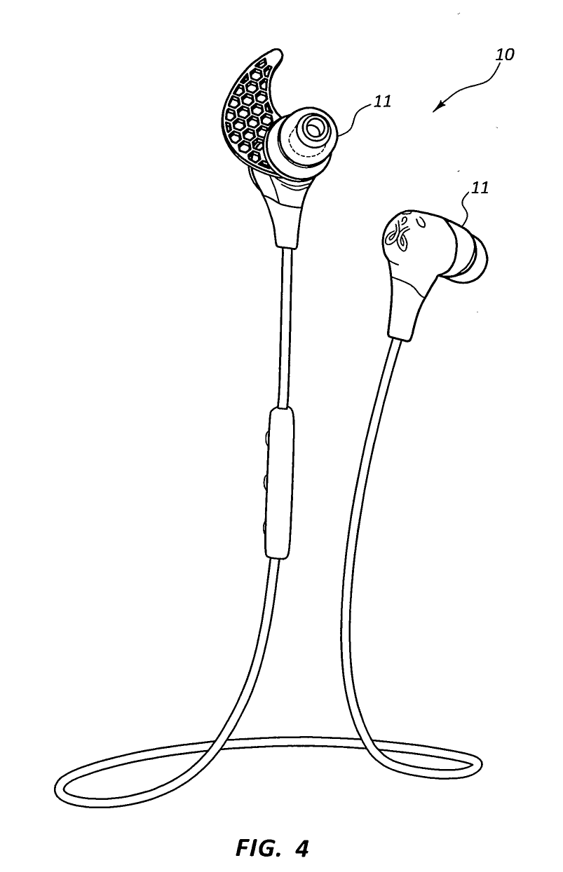

As shown in FIG. 1, the earphone tip 11 of the present invention 10 is angled up and forward relative to the outside of an ear to align with the ear canal. The earphones can be worn either over ear as shown in FIG. 2 or under ear as shown in FIG. 3 with the up and forward angle alignment of the earphone tips 11 providing a precise fit in either wearing positions. All a user has to do to switch from the over the ear fit to the under ear fit is to reverse the earphones. For example, the earphone that was in the right ear in the over ear position would be switched to the left ear in the under ear position. In this manner the earphone tip 11 are always properly aligned with the ear canal.

As shown in FIGS. 2 and 3, the earphones 10 are anchored by the ear cushions 13 being held behind the anti-tragus 14 and anti-helix 15 in the lower part of the concha 16 of the ear 17. The ear canal runs forward and up. If the earphone tip 11 were straight like existing earphones are, the tail end of the earphone, or strain relief 18, would not point in the right direction for over ear wearing option. By angling the earphone tip 11 forward and up, and the strain relief 18 inwards, the present invention provides a snug, comfortable, secure and acoustically sound fit for either the under or over ear wearing options. Because earphone tip 11 is angled to align with the natural angles of the ear 17, its helps maintain optimum sound isolation and comfort, while also pointing the strain relief 18 over the correct location on the ear 17 for over ear wearing. The additional inwards angle of the strain relief 18 assists further and balances responsibility in achieving the required angle of the earphone tip 11. The angles are just as effective in the under ear mode as they keep the earphones 10 snug and close to the user's head.

Existing earphones do not provide the appropriate up and forward angled earphone tip 11 of the present invention. They cannot be worn in either over ear or under ear fashion without the use of earhooks and do not provide the precise fit of the present invention. Through its specially angled earphone tip 11 and specially angle strain relief 18, the present invention provides excellent sound isolation in either wearing style for quality audio performance during rigorous activity.

What is claimed is:

1. A customizable over/under ear-fit earphone having:
an angled earphone tip; and
an angled strain relief.

2. The earphone of claim 1 wherein the angle of the earphone tip is aligned with the angle of an ear canal.

3. The earphone of claim 1 wherein the angle of the strain relief is acute relative to a user's head.

4. The earphone of claim 2 wherein the angle of the strain relief is acute relative to a user's head.

5. The earphone of claim 1 wherein the angled strain relief points toward the top of the ear.

6. The earphone of claim 1 wherein the angled strain relief points toward the bottom of the ear.

7. The earphone of claim 1 where the angled strain relief can be worn pointing either toward the top of the ear or the bottom of the year depending on the wearer's preference.
